(19) United States
(12) Patent Application Publication
(10) Pub. No.: US 2009/0067629 A1
(43) Pub. Date: Mar. 12, 2009

(54) Table-based encryption/decryption techniques for gaming networks, and gaming networks incorporating the same

(75) Inventor: Frank John Kraszewski, Mundelein, IL (US)

Correspondence Address: NIXON & VANDERHYE, PC, 901 NORTH GLEBE ROAD, 11TH FLOOR, ARLINGTON, VA, 22203, US

(73) Assignee: PALTRONICS, INC., Crystal Lake, IL (US)

(21) Appl. No.: 11/896,913

(22) Filed: Sep. 6, 2007

(51) Int. Cl. H04L 9/00; H04K 1/00

(52) U.S. Cl. 380/251; 380/44

(57) ABSTRACT

The exemplary embodiments described herein relate to a light-weight encryption/decryption technique for peripherals (e.g., gaming machines, overhead displays, a jackpot controllers, etc.) attached to gaming networks. In certain exemplary embodiments, a peripheral device for use in a networked gaming environment is provided. A network interface is configured to send and receive at least one data stream, with each said data stream including at least a data block and a predetermined portion to be used in key generation. An encrypt table includes an index of random numbers in a predetermined range, with the encrypt table size and the range of the random numbers being set in dependence on the predetermined portion of the data stream. A decrypt table is provided, with the decrypt table being the inverse of the encrypt table. Key generating programmed logic circuitry is configured to generate a key in dependence on the predetermined portion of the data stream. Encrypting programmed logic circuitry is configured to generate an encrypted data stream by encrypting a data block of an unencrypted data stream for encrypted transmission via the network interface in dependence on the key and the encrypt table. Decrypting programmed logic circuitry is configured to generate a decrypted data stream by decrypting a data block of an encrypted data stream received by the network interface in dependence on the key and the decrypt table.

### TECHNICAL FIELD

The exemplary embodiments described herein relate to encryption/decryption techniques for gaming networks and, more particularly, to a light-weight encryption/decryption technique for peripherals (e.g., gaming machines, overhead displays, a jackpot controllers, etc.) attached to gaming networks.

### BACKGROUND AND SUMMARY

For years, gaming machines (e.g., of the type typically found in casinos, on riverboats, and/or in other gambling establishments) have provided patrons with enjoyment and proprietors with revenue. Broadly speaking, they have evolved from simple, classic slot machines featuring mechanical arms that a patron would pull, to more complicated video-based versions of slots, poker, and other games, with one or more buttons sometimes replacing the functions served by the mechanical arm. Further changes have included, for example, incorporating multiple displays to support advertising and/or even additional games.

As the desire for more engaging entertainment has increased yet further, some providers have configured their gaming machines for use in a networked environment. The use of the networked environment has enabled the implementation of progressive jackpot games, streaming updates (including, e.g., jackpot amounts, cumulative payouts, etc.) to overhead displays, etc.

As more and more services are being deployed and/or made available across the network, the need for secure communications has become more and more important. For example, securing the communications would reduce the chances of tampering with the probabilities of games, the amount of awards, etc. It also would reduce the chances of interference with regularly displayed information including, for example, the pirating of existing communication channels to display incorrect, mislead, or otherwise inappropriate materials on the display. Also, securing the communication channels would protect those parties that have invested in infrastructure by reducing the chances of unauthorized peripherals (e.g., gaming machines, overhead displays, etc.) connecting to the network.

However, the gaming industry has not adjusted accordingly, despite the existence of the number of heavy-duty security solutions available. That is, in the gaming industry, data simply is sent in the clear. Part of the technical problem associated with implementing such security solutions has been trying to adapt them for use in the gaming environment. For example, the peripherals on which they are expected to run tend to have limited resources in terms of, for example, processing power, memory or other storage locations, etc. Another technical challenge relates to the variety of different peripherals in place throughout a gaming environment, both in terms of purpose, style, age, and technical ability of each said peripheral.

Thus, it will be appreciated that there is a need in the art for a light-weight encryption/decryption technique for use with peripherals connected to a gaming networks.

In certain exemplary embodiments, a peripheral device for use in a networked gaming environment is provided. A network interface is configured to send and receive at least one data stream, with each said data stream including at least a data block and a predetermined portion to be used in key generation. An encrypt table includes an index of random numbers in a predetermined range, with the encrypt table size and the range of the random numbers being set in dependence on the predetermined portion of the data stream. A decrypt table is provided, with the decrypt table being the inverse of the encrypt table. Key generating programmed logic circuitry is configured to generate a key in dependence on the predetermined portion of the data stream. Encrypting programmed logic circuitry is configured to generate an encrypted data stream by encrypting a data block of an unencrypted data stream for encrypted transmission via the network interface in dependence on the key and the encrypt table. Decrypting programmed logic circuitry is configured to generate a decrypted data stream by decrypting a data block of an encrypted data stream received by the network interface in dependence on the key and the decrypt table.

In certain other exemplary embodiments, a network for use in a gaming environment. The network includes a jackpot controller and a plurality of peripheral devices. Each peripheral device and the jackpot controller includes a network interface is configured to send and receive at least one data stream, with each said data stream including at least a data block and a predetermined portion to be used in key generation. An encrypt table includes an index of random numbers in a predetermined range, with the encrypt table size and the range of the random numbers being set in dependence on the predetermined portion of the data stream. A decrypt table is provided, with the decrypt table being the inverse of the encrypt table. Key generating programmed logic circuitry is configured to generate a key in dependence on the predetermined portion of the data stream. Encrypting programmed logic circuitry is configured to generate an encrypted data stream by encrypting a data block of an unencrypted data stream for encrypted transmission via the network interface in dependence on the key and the encrypt table. Decrypting programmed logic circuitry is configured to generate a decrypted data stream by decrypting a data block of an encrypted data stream received by the network interface in dependence on the key and the decrypt table.

These exemplary features, aspects, and advantages may be combined in various combinations ways to achieve yet further embodiments.

### BRIEF DESCRIPTION OF THE DRAWINGS

These and other features, aspects, and advantages will be better and more completely understood by reference to the following detailed description of exemplary illustrative embodiments in conjunction with the drawings, of which:

FIG. 1 shows a plurality of gaming machines and associated peripherals being located on a casino floor and being connected in a networked environment;

FIG. 2 is an illustrative block diagram of certain components of a peripheral device capable of supporting the encryption/decryption techniques of certain exemplary embodiments;

FIG. 3 is an illustrative flowchart demonstrating an encryption process in accordance with an exemplary embodiment; and,

FIG. 4 is an illustrative flowchart demonstrating a decryption process in accordance with an exemplary embodiment.

### DETAILED DESCRIPTION

The exemplary embodiments described herein relate to encryption/decryption techniques for gaming networks and, more particularly, to a light-weight encryption/decryption technique for peripherals (e.g., gaming machines, overhead displays, a jackpot controllers, etc.) attached to gaming networks. According to certain exemplary embodiments, a peripheral device for use in a networked gaming environment is provided. A network interface is configured to send and receive at least one data stream, with each said data stream including at least a data block and a predetermined portion to be used in key generation. An encrypt table includes an index of random numbers in a predetermined range, with the encrypt table size and the range of the random numbers being set in dependence on the predetermined portion of the data stream. A decrypt table is provided, with the decrypt table being the inverse of the encrypt table. Key generating programmed logic circuitry is configured to generate a key in dependence on the predetermined portion of the data stream. Encrypting programmed logic circuitry is configured to generate an encrypted data stream by encrypting a data block of an unencrypted data stream for encrypted transmission via the network interface in dependence on the key and the encrypt table. Decrypting programmed logic circuitry is configured to generate a decrypted data stream by decrypting a data block of an encrypted data stream received by the network interface in dependence on the key and the decrypt table.

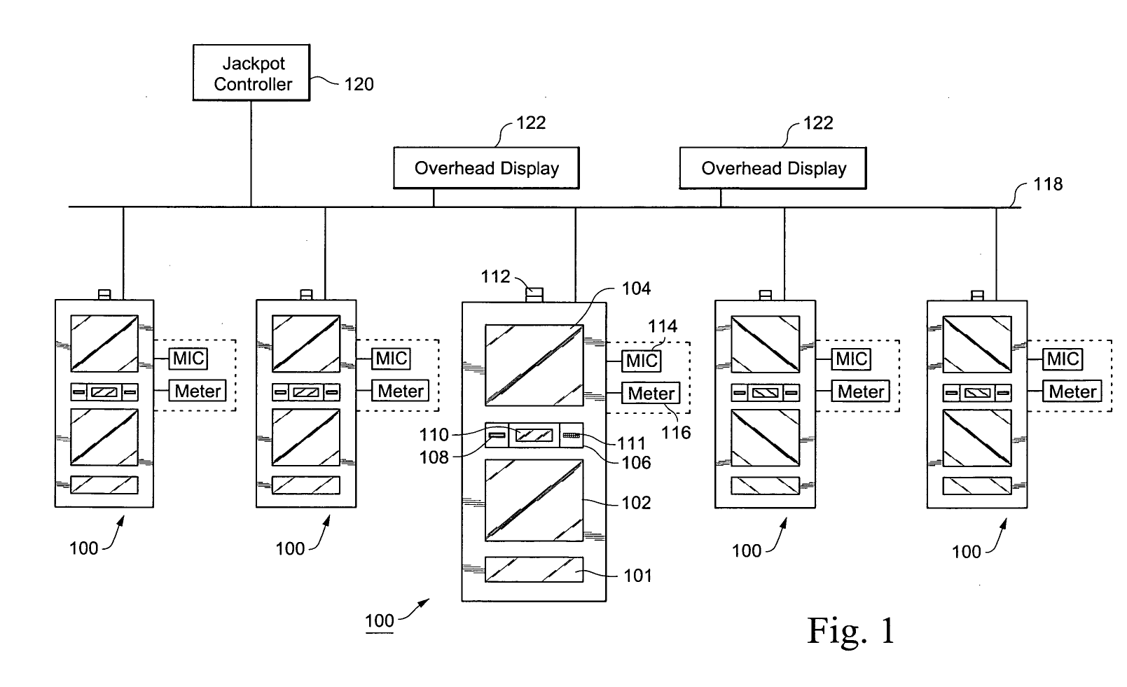

Referring now more particularly to the drawings, FIG. 1 shows a plurality of gaming machines 100 and associated peripherals being located on a casino floor and being connected in a networked environment. For aesthetic purposes, belly glass 101 often is provided on gaming machines. Each gaming machine includes a first display area 102, generally referred to as a game screen. The game screen 102 traditionally has been where most of the “action” happens. For example, the game screen 102 may simulate the rolling of the reels on a slot machine and thus indicate whether the user has won any money. A second display area 104, generally referred to as a top box, also is provided. The top box 104 may display additional information for the patron, such as, for example, advertising, generally entertaining animations, bonus game opportunities, etc.

The game screen 102 and/or the top box 104 may be touch screen monitors and thus accept input directly. Such input may pertain to, for example, the number of credits to bet, the way in which a bet may be made, whether to initiate a bet, whether to cash out, etc. In other cases, a separate control panel (not shown) may be provided to enable the same and/or similar functionality.

The gaming machine 100 also is provided with a player tracking module (PTM) area 106. The PTM area 106 includes a payment acceptor (e.g., a card reader, a coin and/or dollar acceptor, etc.) 108 to accept payment (e.g., cash, an encoded card storing credits, or the like) from the patron. A small display screen (or PTM) 110 is located in the PTM area 106 and enables the patron to access certain other more individualized services. For example, the PTM 110 may enable the patron to call an attendant to order drinks. In such a case, the PTM 110 may cause the candle 112 (e.g., one or more differently colored lights) of the gaming machine 100 to become lit to signal to casino personnel that the patron is requesting some form of service. The PTM 110 typically is an LCD screen and typically is operated using control panel 111.

The PTM 110 may have a computer-readable storage medium (not shown) associated therewith. The computer-readable storage medium typically is a small flash drive, hard drive, or other suitable memory location. Information may be distributed to the PTM 110 and at least temporarily stored on the computer-readable storage medium. In this way, it is possible to provide some media offerings to the gaming machine 100 for display by the PTM 110. More particularly, the computer-readable storage medium is used as a buffer for the media offerings that ultimately may be displayed by the PTM 110.

The game screen 102 and the top box 104, and the respective associated circuitry, typically are provided by a single company. The PTM 110 often is provided by another vendor. Sometimes, the PTM 110 will be integrated into the gaming machine 100. However, it is often the case that the gaming machine 100 will be retrofitted with a PTM 110. As such, the hardware and software systems for the game screen 102 and the top box 104 typically are independent of the hardware and software systems for the PTM 110.

This separation often makes integration between the various components cumbersome. Thus, to accommodate these features related to the PTM area 106, gaming machines are equipped with special purpose hardware. It will be appreciated that the player management tracking and information management features provided typically exist outside of the normal base game(s) environment, which deal directly with game play rather than ancillary services, patron interaction, feedback, and the like.

It will be appreciated that although the gaming machines 100 shown in FIG. 1 all appear the same, the present invention is not so limited. A wide variety of gaming machines may be provided, as may table games, roulette tables, etc. Variations to each may include changes in terms of configuration, style, type, functionality, payoffs, etc.

In many cases, an RS-485 connection is utilized. The connection often is to a machine interface card (or MIC) 114 located within each gaming machine. In essence, the MIC 114 translates between the gaming machine 100 and the network 118, making all such gaming machines appear to be the same from the perspective of the network 118.

As alluded to above, a plurality of gaming machines 100 may be located on a casino floor and being connected in a networked environment, e.g., via network 118. To this end, a plurality of central systems (not shown) are connected to the networked environment to collect and/or distribute data, as necessary. Each gaming machine 100 may be connected to one or more of the central systems via a network link. Such network links typically are proprietary and are based on unicast, broadcast, multi-drop, and/or other suitable network protocols. Although proprietary protocols often are implemented, the typical effect is that data is transmitted to/from the central systems over a broadcast channel or to one or more targeted groups (e.g., a bank of gaming machines in a row, in a particular area of the gaming floor, etc.) over connections.

There are at least three separate systems or modules comprising the central systems. A first system, management and accounting subsystem, provides management and accounting functions, also sometimes called auditing functions. Typically, these functions gather and/or report coin-in and coin-out operations, door openings (e.g., when a gaming machine is serviced), service cycles in general, ticket replacements, and the like. This activity generally is linked to the game being played on the gaming machine and/or the gaming machine itself.

A second system, player tracking subsystem, provides player tracking functions. More specifically, such systems link players on the gaming floor to particular activities undertaken by the players on the gaming floor. The information typically tracked for each player includes, for example, the session of game play (e.g., date, time, location, type of machine, type of game, etc.) as well as the individual's profile (e.g., name, address, and/or other identifying information such as hair color). The player tracking subsystem also may interface with the PTM 110 of a particular gaming machine 100.

A third system, bonusing subsystem, provides enhancements which may or may not be related to the base game. Such enhancements may relate to bonusing, progressive games, mystery, secondary games, random rewards (e.g., as disclosed in U.S. Pat. No. 6,626,758, the entire contents of which are hereby incorporated herein by reference), etc. This system typically interfaces with the PTM 110.

Other systems may be included in the central systems 114. For example, other modules may be provided for detecting cash-in, cash out and/or data mining purposes. Data mining may be used, for example, in connection with marketing activities, accounting and/or auditing activities, etc.

Reports may be generated by the central systems, for example, to report on earnings, operational efficiencies, repairs, etc. Such reports also may be the result of the above-described data mining operations.

An in-machine meter 116 may be provided to the gaming machines 100 to cooperate with the central systems (e.g., to provide information regarding game plays, amounts of wagers, payoffs, etc.).

In addition to the gaming machines 100 existing in the network, one or more overhead displays 122 may be connected to the network 118. The overhead displays 122 may receive data from the central systems indicating, for example, the jackpot amount(s) (e.g., current, daily, monthly, etc.), payouts (e.g., current, daily, monthly, etc.), winners, etc.

A jackpot controller 120 also is connected to the network 118. A single jackpot controller may be assigned to a bank of gaming machines 100. Typically, a jackpot controller is configured to accept a single bank of up to 124 gaming machines. The jackpot controller 120 may be responsible for calculating jackpots, changing the turnover on every hit and/or on every play, returning the winning amounts, etc. The jackpot controller 120 may be a progressive jackpot controller or it may be a non-progressive jackpot controller.

Given these communications, it would be advantageous to effectively scramble the data transmitted over the network 118.

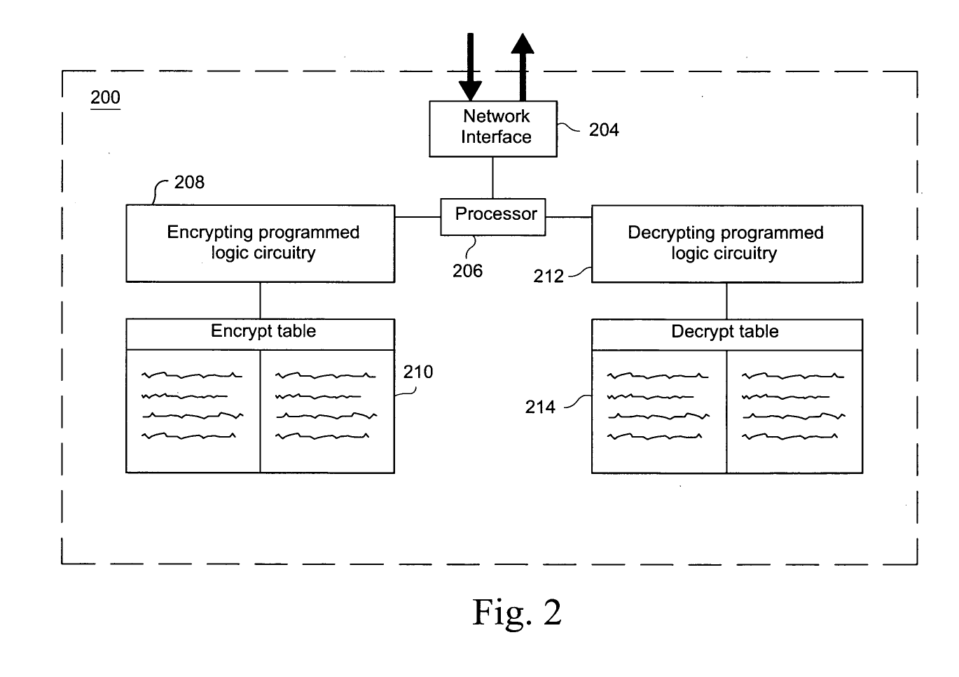

FIG. 2 is an illustrative block diagram of certain components of a peripheral device 200 capable of supporting the encryption/decryption techniques of certain exemplary embodiments. It will be appreciated that the same or similar components shown in FIG. 2 may be provided to each peripheral (e.g., gaming machines, jackpot controllers, overhead displays, etc.) connected to the network 118. In FIG. 2, a network interface 204 is configured to send and receive data. A processor 206 is configured to invoke the encrypting programmed logic circuitry 208 and/or the decrypting programmed logic circuitry 212 as appropriate.

Associated with the encrypting programmed logic circuitry 208 is an encrypt table 210, and associated with the decrypting programmed logic circuitry 212 is a decrypt table 214. A data stream received by the network interface 204 may be processed in bytes, with each byte comprising 8 bits. In such a case, the encrypt table 210 will include 256 numbers (e.g., 0 to 255) indexed in a random order. The decrypt table 214 will be the inverse of the encrypt table 210. Thus, for example, in the encrypt table 210, at an index position 10 having a random number 100 associated therewith, the decrypt table 214 would have at index position 100 the number 10 associated therewith. Of course, this is provided by way of example and without limitation. Also, it will be appreciated that the data stream received by the network interface 204 may be processed in a way other than bytes (e.g., in groups of bytes, in hex, etc.), and the number of elements in the encrypt table 210 and the decrypt table 214 may be adjusted accordingly. Ideally, every peripheral attached to the network will have access to these tables. For example, the tables may be stored on each peripheral device in a storage location, such as a memory location, on disk, in firmware (which optionally may be updatable), etc. Embedding the tables in firmware, for example, makes them difficult to find, especially by a casual network snoop.

A typical stream transmitted over an RS-485 connection includes the main data block and a 2-byte CRC (cyclic redundancy check) located at the end of the stream. In certain exemplary embodiments, the CRC may be used to generate a key for encryption and decryption purposes. Of course, it will be appreciated that any part of the stream (which may be greater than or less than 2 bytes, for example) may be used as a key, provided that an agreement is reached in advance of the transmission.

To encrypt the data, the encrypting programmed logic circuitry 208 generates the unencrypted transmission packet and corresponding CRC. Both bytes of the CRC are xored to create the key. The first data byte is xored with the key. That result is used as an index into the random number table (e.g., the encrypt table 210) to arrive at the first encrypted data byte. This process is repeated for the entire data block. Note that the network interface 204 sends the data block in its encrypted form but sends the CRC in its original form.

The following is pseudo-code for such encryption:

Key = CRCHibyte \hat{ } CRCLobyte;
for ( i = 0; i < len; i++)
{
encrypted[i] = encryptTable[Key \hat{ } TxData[i]];
}

Here, the CRCHibyte and CRCLobyte correspond to the two bytes of the transmitted CRC. The “len” variable is the data portion of the packet and does not include the CRC. The “I” operator is a bitwise xor.

The key may be created by one or more of the processor 206, by the encrypting programmed logic circuitry 208, by the decrypting programmed logic circuitry 212, by separate key generating programmed logic circuitry (not shown), etc. As used herein, programmed logic circuitry is broad enough to encompass any suitable combination of hardware, software, firmware, and/or the like.

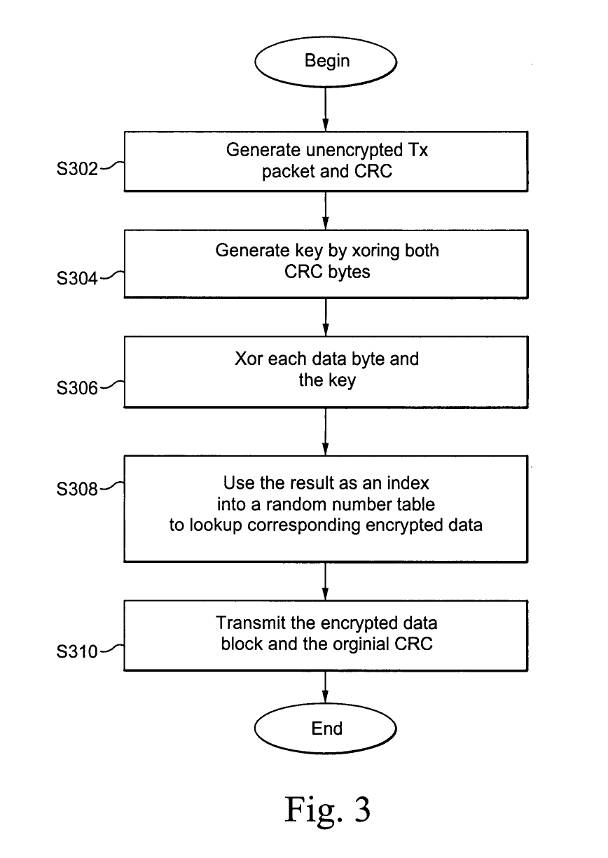

FIG. 3 is an illustrative flowchart demonstrating an encryption process in accordance with an exemplary embodiment. FIG. 3 summarizes this process. In step S302, an unencrypted transmission packet and a CRC are generated. In step S304, a key is generated by xoring both CRC bytes. In step S306, each data byte is xored with the key. In step S308, the result is used as an index into a random number table to lookup corresponding encrypted data. In step S3 10, the encrypted data block and the original CRC are transmitted.

To decrypt the data, the decrypting programmed logic circuitry 212 receives both bytes of the CRC and xors them to generate the key. The received encrypted data is used as an index into the decrypt table 214. This data is xored with the key to generate the decrypted data. Thus, the data is decrypted and in a usable format.

The following is pseudo-code for such decryption:

Key = CRCHibyte \hat{ } CRCLobyte;
for ( i = 0; i < len; i++)
{
decrypted[i] = decryptTable[RxData[i]] \hat{ } Key;
}

Here, the CRCHibyte and CRCLobyte correspond to the two bytes of the received CRC. As before, the “len” variable is the data portion of the packet and does not include the CRC. The “I” operator still is a bitwise xor.

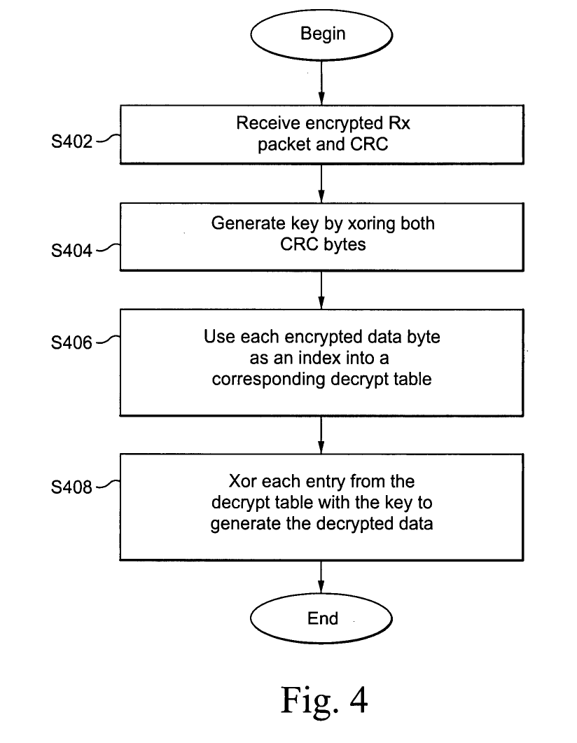

FIG. 4 is an illustrative flowchart demonstrating a decryption process in accordance with an exemplary embodiment. FIG. 4 summarizes this process. In step S402, the encrypted receive packet and CRC are received. In step S404, a key is generated by xoring both CRC bytes. In step S406, each encrypted data byte is used as an index into a corresponding decrypt table. In step S408, each entry from the decrypt table is xored with the key to generate the decrypted (or original) data.

Although certain exemplary embodiments have been described as relating to a network with RS-435 connections, the present invention is not so limited for example, certain exemplary embodiments may be implemented in connection with an Ethernet network. XML data may be transmitted among and/or between peripherals, and this data may be hidden using a technique the same as or similar to one described above.

Additionally, multiple encrypt/decrypt table pairings may be disposed throughout a gaming environment. For example, each bank of gaming machines may have its own encrypt/decrypt table pairing, gaming machines may have a first encrypt/decrypt table pairing while table games may have a second encrypt/decrypt table pairing, etc. Multiple indexing similarly may be provided, whereby the indexes obtained as above may be further xored (e.g., with the now partially encrypted data) to be used as indexes into secondary (or tertiary, etc.) tables.

Also, as alluded to above, the encrypt/decrypt tables need not be static. Instead, they may be updatable. For example, they may be updated with firmware updates, periodically, randomly, etc. to provide added randomization and/or security. Instead or in addition, more robust techniques (e.g., RSA, SSL, etc.) could then be used for updating the firmware and/or the encrypt/decrypt tables. This may be advantageous because although these areas tend to be more sensitive, updates may be performed at scheduled maintenance times, e.g., where usage is low and resources are high.

The techniques described herein convey numerous advantages, both over the conventional technique of sending data in the clear and using high-powered, robust encryption/description techniques. For example, certain exemplary embodiments described herein may be implemented using very low computation resources. This is particularly advantageous for older gaming machines. It would be difficult to determine the general scheme and/or key structure because the data would not appear constant because of the many key changes. For example, where a CRC is used to determine the key, the CRC changes if a transmission ID, date/time stamp, etc. is included in the data block. Also, even if a snoop knew of the general encryption/description scheme, the data nonetheless would be protected (e.g., because the snoop would not be aware of the encrypt/decrypt table contents). Thus, it is possible to achieve a lightweight deterrent executable by a wide range of current gaming environment peripherals without significant slowdown in the network or in the peripherals, retrofitting, etc.

It will be appreciated that although certain exemplary embodiments have been described as relating to gaming machines and table games, the present invention is not so limited. For example, the exemplary techniques associated with gaming machines may be used on table games, and vice versa. Moreover, the exemplary techniques may be used on both gaming machines and table games, simultaneously, in a suitably configured networked environment. Also, the techniques may be applied to roulette tables, bingo games, etc., as well as one or more portions of the central systems, including, for example, the management and accounting subsystem, player tracking subsystem, bonusing subsystem, etc. Of course, it will be appreciated that the exemplary techniques described herein may be applied to any communications among and/or between any two or more devices in any gaming network environment.

It will be appreciated that virtually any kind of communications signals may be encrypted/decrypted using the techniques of certain exemplary embodiments. For example, with respect to gaming machines, the techniques of certain exemplary embodiments may be applied to game-related signals (e.g., number of wagers, wager amounts, wager types, amount won, etc., and/or the same for a base game, bonus game, etc.) or ancillary signals (e.g., PTM-related requests, etc.), etc. With respect to table games, for example, the techniques of certain exemplary embodiments may be applied to signals pertaining to the table game itself, bonus games provided to the table game, player data, and/or ancillary signals (e.g., PTM-related requests, etc.), etc. Communications between the peripherals and the central systems (e.g., jackpot amounts, current payouts, player information, management and accounting data, and the like) also may take advantage of the techniques of certain exemplary embodiments. Of course, these exemplary signals are provided by way of example and without limitation.

Although certain exemplary embodiments have been described as relating to gaming machines and table games in casinos, it will be appreciated that the present invention is not so limited. For example, the exemplary embodiments described herein may be used in connection with casinos, riverboats, restaurants, hotels, etc.

Thus, the exemplary features, aspects, and advantages described herein may be combined in yet further ways to achieve further embodiments.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A peripheral device for use in a networked gaming environment, comprising:
a network interface configured to send and receive at least one data stream, each said data stream including at least a data block and a predetermined portion to be used in key generation;
an encrypt table including an index of random numbers in a predetermined range, the encrypt table size and the range of the random numbers being set in dependence on the predetermined portion of the data stream;
a decrypt table, the decrypt table being the inverse of the encrypt table;
key generating programmed logic circuitry configured to generate a key in dependence on the predetermined portion of the data stream;
encrypting programmed logic circuitry configured to generate an encrypted data stream by encrypting a data block of an unencrypted data stream for encrypted transmission via the network interface in dependence on the key and the encrypt table; and,
decrypting programmed logic circuitry configured to generate a decrypted data stream by decrypting a data block of an encrypted data stream received by the network interface in dependence on the key and the decrypt table.

2. The peripheral device of claim 1, wherein the peripheral device is a gaming machine.

3. The peripheral device of claim 1, wherein the peripheral device is a jackpot controller.

4. The peripheral device of claim 1, wherein the peripheral device is an overhead display

5. The peripheral device of claim 1, wherein the predetermined portion of the data stream is a two-byte CRC of the data stream.

6. The peripheral device of claim 5, wherein the key generating programmed logic circuitry is configured to generate the key by xoring each byte of the CRC.

7. The peripheral device of claim 1, wherein the encrypting programmed logic circuitry is configured to generate the encrypted data stream by xoring the key with each byte in the unencrypted data stream to generate an index and then generating the encrypted data stream by using the index in connection with the encrypt table to determine a corresponding encrypted data byte for inclusion in the encrypted data stream.

8. The peripheral device of claim 1, wherein the decrypting programmed logic circuitry is configured to generate a decrypted data stream by xoring the key with each byte in the encrypted data stream to generate an index and then generating the decrypted data stream by using the index in connection with the decrypt table to determine a corresponding decrypted data byte for inclusion in the decrypted data stream.

9. The peripheral device of claim 1, further comprising firmware storing the encrypt table and the decrypt table.

10. The peripheral device of claim 9, wherein the firmware is remotely updatable.

11. A network for use in a gaming environment, comprising:
a jackpot controller; and,
a plurality of peripheral devices, each said peripheral device and the jackpot controller comprising:
a network interface configured to send and receive at least one data stream over the network, each said data stream including at least a data block and a predetermined portion to be used in key generation,
an encrypt table including an index of random numbers in a predetermined range, the encrypt table size and the range of the random numbers being set in dependence on the predetermined portion of the data stream,
a decrypt table, the decrypt table being the inverse of the encrypt table,
key generating programmed logic circuitry configured to generate a key in dependence on the predetermined portion of the data stream,
encrypting programmed logic circuitry configured to generate an encrypted data stream by encrypting a data block of an unencrypted data stream for encrypted transmission via the network interface in dependence on the key and the encrypt table, and
decrypting programmed logic circuitry configured to generate a decrypted data stream by decrypting a data block of an encrypted data stream received by the network interface in dependence on the key and the decrypt table.

12. The network of claim 11, wherein the at least one peripheral device is a gaming machine or overhead display.

13. The network of claim 11, wherein the predetermined portion of the data stream is a two-byte CRC of the data stream.

14. The network of claim 13, wherein the key generating programmed logic circuitry is configured to generate the key by xoring each byte of the CRC.

15. The network of claim 11, wherein the encrypting programmed logic circuitry is configured to generate the encrypted data stream by xoring the key with each byte in the unencrypted data stream to generate an index and then generating the encrypted data stream by using the index in connection with the encrypt table to determine a corresponding encrypted data byte for inclusion in the encrypted data stream.

16. The network of claim 11, wherein the decrypting programmed logic circuitry is configured to generate a decrypted data stream by xoring the key with each byte in the encrypted data stream to generate an index and then generating the decrypted data stream by using the index in connection with the decrypt table to determine a corresponding decrypted data byte for inclusion in the decrypted data stream.

17. The network of claim 11, further comprising firmware storing the encrypt table and the decrypt table.

18. The network of claim 17, wherein the firmware is remotely updatable across the network.

19. The network of claim 11, further comprising a plurality of jackpot controllers, each said peripheral device being associated with one said jackpot controller,
wherein each jackpot controller and its associated peripheral devices communicate over the network using encrypt and decrypt tables separate from the other jackpot controllers and their associated peripheral devices.

20. The network of claim 11, wherein the network is an Ethernet network and the data streams to be communicated across the network correspond to XML files.
